(19) United States
(12) Patent Application Publication
(10) Pub. No.: US 2003/0016819 A1
(43) Pub. Date: Jan. 23, 2003

(54) Secure socket layer (SSL) load generation with handshake replay

(76) Inventor: Lebin Cheng, Fremont, CA (US)

Correspondence Address: HEWLETT-PACKARD COMPANY, Intellectual Property Administration, P.O. Box 272400, Fort Collins, CO, 80527-2400, US

(21) Appl. No.: 09/908,591

(22) Filed: Jul. 20, 2001

(51) Int. Cl. H04K 1/00

(52) U.S. Cl. 380/2

(57) ABSTRACT

A software method is disclosed for generating a test load of secure socket layer (SSL) transactions on a server. The method uses a recording phase and a testing phase. During the recording phase, a client initiates an SSL handshake protocol with the server, randomly generates a session key, uses the server's public key certificate to encrypt the session key, sends the session key to the server, and records the session key and an encrypted version of the session key. During the testing phase, the client initiates multiple SSL test transactions. During each test transaction, the client suggests as the session key the same session key that was recorded during the recording phase, rather than generating and encrypting a new session key for each transaction. The client sends the session key to the server for each of the test transactions, and the server decrypts the session key.

### FIELD OF INVENTION

The present invention relates generally to network communications. More particularly, it relates to a method and system for testing secure socket layer (SSL) performance of a network server.

### BACKGROUND

Secure Socket Layer (SSL) or Transport Layer Security (TLS) is the underlying technology of the secure hypertext transfer protocol (HTTP) widely used in secure commerce via a network, such as a global computer network such as the Internet.

The purpose of SSL is to provide a secure end-to-end communication channel between a client and a server. SSL does this by means of digital cryptography, the details of which are widely available. Normal messages between SSL clients and servers are encrypted by symmetric cryptography. It is symmetric in that the same key is used by the client and server to encrypt and decrypt contents. Most symmetric cryptography, such as the popular RC-4, can be done efficiently in software. The problem is that there needs to be a safe and secure way for an SSL client and server to agree on a symmetric secret key. Existing methods and systems do this at the beginning of every SSL session. Referred to as the SSL handshake, this process allows an SSL client to authenticate the server and establish security associations with the server. Among other things, security associations in an SSL session include a symmetric session key.

SSL handshake protocol uses asymmetric cryptography, also referred to as public-key cryptography. One advantage of using asymmetric cryptography is that clients and servers do not need a shared secret for secure communication. An SSL server publishes its certified public key, for example as a server certificate. With a server certificate, a client can initiate the handshake by encrypting a session key using the server's public key. The session key is safe because no one except for the server who has the corresponding private key can decrypt and retrieve the session key. The session key is then used to secure subsequent messages exchanged between the client and server.

Despite its security benefits, SSL operations consume significant computing resources of server machines. Therefore, it is desirable for a web commerce service provider to test and/or monitor the performance impact of SSL transactions by generating an SSL load on the server. SSL performance measurement is more difficult than measuring normal HTTP performance because SSL traffic is encrypted. Both public-key encryption and decryption involve central processing unit (CPU)-intensive modular operations. In order to complete the initial SSL handshake process, an SSL client, such as a terminal connected to the network, must correctly generate and interpret encrypted contents. Generating an SSL load cost-effectively is difficult because public-key cryptography operations are computationally expensive. Conventional tests require the client to perform the same computationally expensive cryptography operations (in reverse order) as the server. It is difficult for a low-cost, off-the-shelf personal computer to be used as a test client to process a large quantity of public-key encrypted messages. As a result, conventional SSL performance tests involve expensive client platforms having at least as much, if not more, computing resources to sufficiently stress test an SSL server. These methods and systems are too costly for many users. What is needed is a more efficient method and system for stress testing SSL transactions on a server.

### SUMMARY OF INVENTION

A method is disclosed for generating a test load of secure socket layer (SSL) transactions on a server using a client. The method may be implemented in computer-executable software instructions, such as those stored on a computer-readable medium. The method uses a recording phase and a testing phase. During the recording phase, the client initiates an SSL handshake protocol with the server, randomly generates a session key, uses the server's public key certificate to encrypt the session key, sends the session key to the server, and records the session key and encrypted session key. During the testing phase, the client initiates multiple SSL test transactions. During each test transaction, the client suggests as the session key the same session key that was recorded during the recording phase, rather than generating and encrypting a new session key for each transaction. The client sends the session key to the server for each of the test transactions, and the server decrypts the session key. The server's ability to process the load of transactions may then be analyzed.

A client computer system is also disclosed for generating a load on a server connected to the client by a network. The client generates an SSL load on the server by initiating multiple SSL test transactions with the server, for the purpose of analyzing the server's ability to process multiple SSL transactions. During each test transaction, the client sends the same encrypted session key to the server to minimize the computational resources required by the client. The session key is generated randomly during a recording session between the client and server and is encrypted using the server's public key. The session key is stored during the recording session along with an encrypted session key. The encrypted session key is replayed during each test transaction.

### SUMMARY OF DRAWINGS

FIG. 1 shows a block diagram of a system that may use the method to test a server.

FIG. 2 shows a flow chart of the method for testing the server.

FIG. 3 shows a more detailed flow chart of the method shown in FIG. 2.

FIG. 4 shows a block diagram of the SSL handshake between a client and a server.

FIG. 5 shows a more detailed flow chart of the recording phase shown in FIG. 2.

FIG. 6 shows a more detailed flow chart of the testing phase shown in FIG. 2.

### DETAILED DESCRIPTION

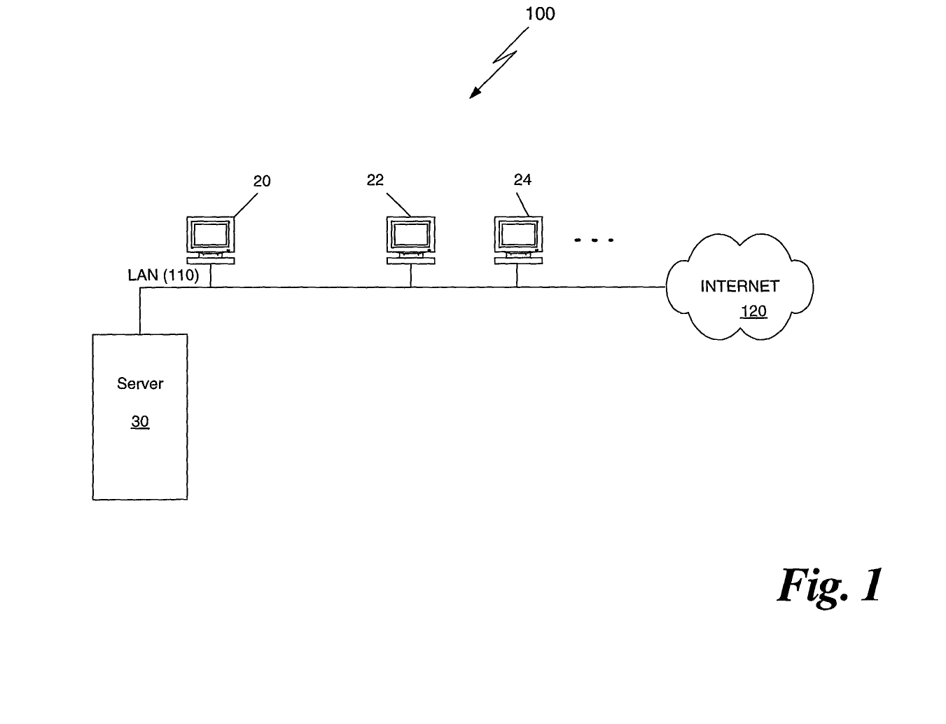

FIG. 1 shows a block diagram of a network 100 on which the handshake method and system may be used. The network 100 in the example of FIG. 1 comprises a server 30 connected to a local area network (LAN) 110, which is in turn connected to a global computer network 120, such as the Internet 120. Client terminals 20, 22, 24 are part of the network 100 and are connected to the server 30 via the LAN 110. The server 30 may use SSL encryption to process transactions on the network 100. The clients 20, 22, 24 may be used to test the server's SSL performance by sending SSL test transactions to the server 30 via the network 100. As used herein, a client 20 refers to any device adapted for connection to a server 30 and implementation of a load-generation consistent with the method described herein or any other method for performing the same or equivalent function. By way of example, a client 20 may include a personal computer 20 or a similar terminal 20 connected to the server 30 via a network 100. The client 20 may interact with the server 30 using software such as a web browser.

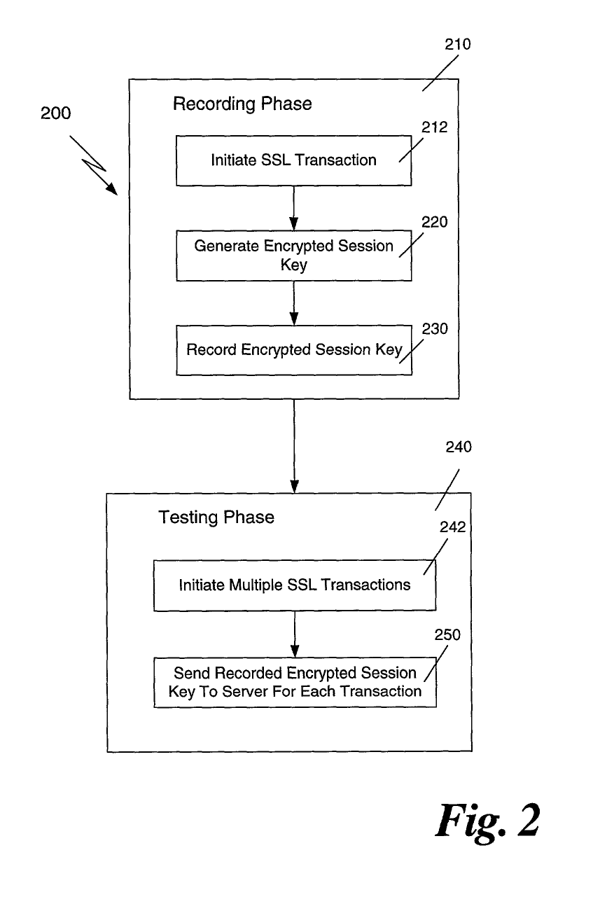

FIG. 2 shows a load generation with handshake replay method 200 of testing the SSL performance of the server 30 using a client 20 connected by a network 100. The method 200 allows the construction of SSL load-generating clients 20 that can successfully complete SSL handshakes with an SSL server 30 without going through expensive client-side SSL operations, such as session-key generation and encryption. Conventional SSL handshake protocol allows a client 20 to suggest a session key to encrypt the SSL transaction. The method 200 takes advantage of this SSL protocol feature by suggesting the same session key for multiple test sessions rather than generating and encrypting a new session key for each test session.

The load-generation process 200 shown in FIG. 2 has two phases: a recording phase 210 and a testing phase 240. During the recording phase 210, the SSL client 20 initiates 212 and completes a normal handshake with the server 30. During the handshake, a session key is created 220. As used herein, a session key refers to any device used to encrypt an SSL transaction, or equivalent transaction, between a client 20 and a server 30. The session key is part of an SSL client-server security association. As used herein, a security association refers to any session information that is based on a session key. In one embodiment, the client 20 and the server 30 agree on security associations during the handshake. An SSL session having a session key may have multiple connections, each of which may use a connection key, based on the session key. The security associations may be used to create a connection key for SSL transactions, which may be valid for a short period of time, for example one hour. The session key may be valid for a specified period of time as well. For example, every eight hours a different session key may be created. In one embodiment, the SSL session key may be generated 220 randomly.

The session key and the encrypted session key, are recorded 230 and stored 230 to a file for use by a subsequent testing phase 240. During the testing phase 240, the client 20 initiates 222 multiple SSL transactions to test the server's ability to handle multiple transactions at the same time. For each transaction, the handshake protocol is the similar to the protocol during the recording phase 210. However, when the encrypted session key is sent 250 to the server 30, the client 20 in the testing phase 220 simply sends the recorded encrypted session key, rather than generating and encrypting a new session key for each transaction. Because the testing method 200 is concerned only with the server's ability to process handshake protocols for multiple transactions, the test is valid even though the server 30 may decrypt the same session key for each transaction. As a result, a load-generation client 20 running on a relatively inexpensive platform can generate enough loads to stress test high-end web commerce server 30—even a server 30 with hardware SSL acceleration.

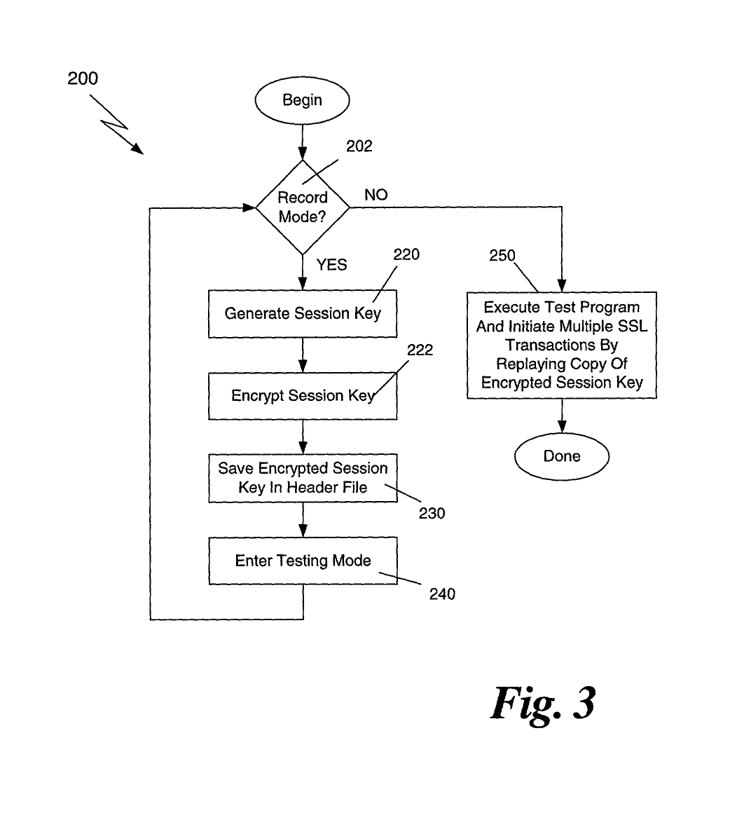

FIG. 3 shows a more detailed flow chart of one embodiment of the method 200. The method 200 may be embodied, for example, in executable software instructions as part of a test program stored in a memory. The test program may be executed by a processor. The memory and processor may be part of a client 20. In one embodiment, the method 200 is added to an existing library codes file that is part of the SSL protocol. In the embodiment shown in FIG. 3, a single software application generates 220 and records 230 the session key. This test program then executed 250 to repeat the SSL transaction multiple times using the same encrypted session key. In one implementation, the test program may be recompiled after the session key is recorded 230. The method 200 first determines 202 whether the client 20 is in recording mode 210, or in a testing mode 240. In one example, a variable or a bit may be set to indicate the mode of the client 20. If the method 200 is in recording mode 210, then the client 20 generates 220 a session key that will be used in the SSL test transactions. The session key is generated 220 randomly in one embodiment. The session key is encrypted 222 and is saved 230 in a data file, also referred to herein as a “header file.” The session key is encrypted 222 using a public key of the server 30 in one embodiment. The method 200 then enters testing mode 240.

In testing mode 240, the method 200 repeats 250 the SSL transaction in multiple instances. The client 20 “spawns” multiple SSL transactions that are sent to the server 30 via the network 100. In the example of FIG. 3, rather than generating 220 and encrypting 230 a new session code, the test program is executed 250 to create multiple SSL transactions, replaying and sending to the server 30 a copy of the encrypted session key for each transaction.

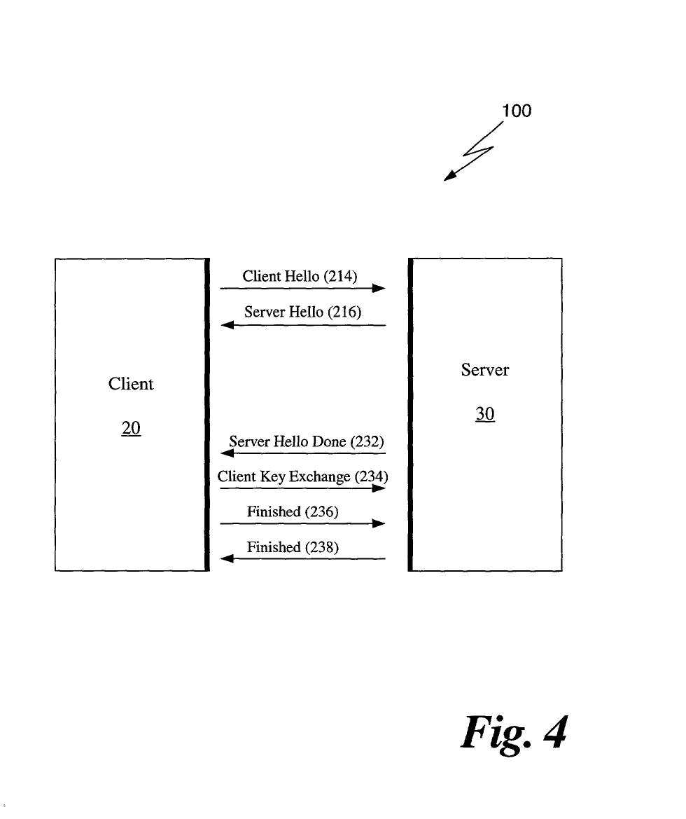

FIG. 4 shows a block diagram of an example key-generation process 210 used by the method 200. The client 20 sends 214 a “Hello” signal to the server 30 to begin a handshake protocol. As known with respect to communication protocols, a “Hello” signal includes any signal for use in initiating the exchange of information according to a particular protocol. The server 30 responds 216 with its own “Hello” signal to the client 20. The example shown in FIG. 4 uses a typical server certificate-only SSL handshake. The client and server “Hello” messages are exchanged 214, 216 without encryption and no optimization is provided for them. The server 30 sends 232 a “Hello Done” signal to indicate that it has sent the client 20 the information needed to begin the transaction. In one embodiment, the server's public key certificate is used to create the session key. A conventional SSL client 20 would need to verify a server 30 certificate, which is a computationally expensive process involving public-key crypto-operations. In one embodiment, this verification process is skipped for the purpose of performance testing because verification is not required. The client 20 suggests a session key and submits 234 the session key encrypted with the server's public key to the server 30, in an SSL message referred to as a “Client Key Exchange.” The server 30 then decrypts the session key. During the recording phase 210, the client 20 suggests a session key by randomly generating 220 a session key and encrypting 222 it. During the testing phase 240, the client 20 simply submits 234 the recorded encrypted session key to the server 30. The client 20 sends 236 a “finish” signal, and the server 30 responds 238 with its own “finish” signal. In one embodiment, the “finished” messages are constructed using hash values of information related to the session key.

During the testing phase 240, multiple instances of SSL transactions can share the same session key. An SSL server 30 interprets any new key exchange as a new SSL session. The SSL server 30 stores and processes the encrypted session key from different SSL sessions in isolation. As a result, despite the use of the session key, multiple instances of a test client 20 generate the same load on the SSL server 30 as if they were separate clients 20, 22, 24 with separate session keys.

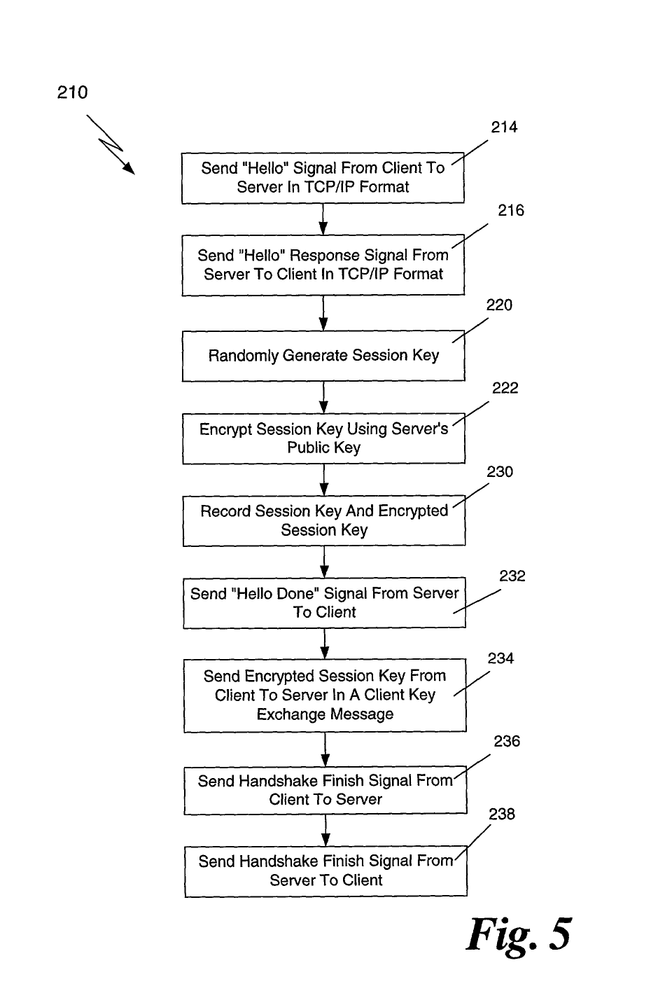

FIG. 5 shows a flow chart of the handshake protocol between a client 20 and a server 30 in recording mode 210. The client 20 sends 214 a “Hello” signal to the server 30, and the server 30 responds 216. The client 20 generates 220 a session key, for example, at random. The session key is encrypted 222 using the server's public key. The session key and encrypted session key are recorded 230 so that the session key may be replayed during a subsequent testing phase 240. The server 30 sends 232 a “Hello Done” signal to indicate that it has sent the client 20 the information needed to begin the transaction. The client 20 sends 234 the encrypted session key to the server 30. The client 20 sends 236 a handshake “finish” signal to the server 30, and the server 30 responds 238 with its own “finish” signal.

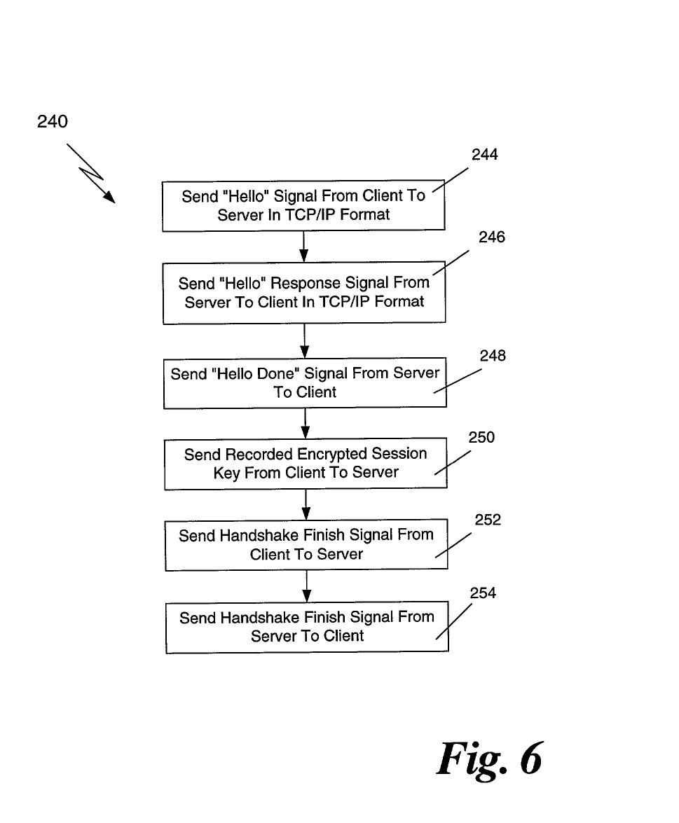

FIG. 6 shows a flow chart of the testing phase 240. The client 20 and the server 30 exchange 244, 246 “Hello” signals, and the client 20 sends 248 a “Hello Done” signal to the server 30. The client 20 then suggests a session key to the server 30 by replaying the recorded encrypted session key and sending 250 it to the server 30. The client 20 and server 30 exchange 252, 254 handshake finish signals, and the method is complete. After the server 30 receives the session key from the client 20, it decrypts the session key as though the SSL transaction was not a test transaction.

In one embodiment, the session key and/or encrypted session key is stored in a header file. This header file is recompiled with library code from a conventional SSL protocol to generate test client 20 executable for the server 30 under test. This header file defines several global variables. In one embodiment, the client 20 may run the SSL load program using the method 200 to test the server 30, or it may also run the same program as a conventional SSL load operation if desired. If the program performs the SSL test, then the program may operate in either a recording mode 210 or in a test mode 240. An integer variable controls whether a test program would run as a normal client 20, a recording client 20, or a test client 20. Integer and unsigned character type variables are used to control behaviors of the SSL handshake library function. A 46-byte variable stores the session key and a 64-byte variable stores the public-key encrypted session key.

Although the present invention has been described with respect to particular embodiments thereof, variations are possible. The present invention may be embodied in specific forms without departing from the essential spirit or attributes thereof. The SSL standard supports a wide variety of digital cryptography algorithms and standards. In particular, although the invention is described with respect to one popular configuration RSA based, server certificate only with RC-4 symmetric keys—one skilled in the art will recognize that the invention applies to general SSL performance tests regardless what cipher standard is chosen. In addition, although the invention is illustrated with respect to SSL transactions, one skilled in the art will recognize that the invention applies to any equivalent secure transaction protocol. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

What is claimed is:

1. A method of generating a secure socket layer (SSL) load on a server, the method comprising:
generating a session key;
storing information related to the session key; and
sending the stored information to a server as part of each of a plurality of SSL test transactions.

2. The method of claim 1, further comprising encrypting the session key, and wherein the step of storing comprises storing the encrypted session key.

3. The method of claim 2, wherein the step of encrypting comprises encrypting the session key using a public key for the server.

4. The method of claim 2, wherein the step of sending comprises sending the same encrypted session key for each of the plurality of transactions.

5. The method of claim 1, wherein the step of storing comprises storing the information to a header file, and further comprising recompiling the header file with library codes for an SSL protocol to create the plurality of SSL test transactions.

6. The method of claim 1, further comprising initiating a session-key recording session between a client and the server using a handshake protocol, and wherein the steps of generating and storing comprise generating and storing during the recording session.

7. The method of claim 6, further comprising initiating the plurality of SSL test transactions during a testing session using a handshake protocol, and wherein the step of sending comprises sending during the testing session.

8. A computer-readable medium having computer-executable instructions for performing a method for generating a secure socket layer (SSL) load on a server, the method comprising:
generating a session key;
storing information related to the session key; and
sending the stored information to a server as part of each of a plurality of SSL test transactions.

9. The medium of claim 8, wherein the method further comprises encrypting the session key, and wherein the step of storing comprises storing the encrypted session key.

10. The medium of claim 9, wherein the step of encrypting comprises encrypting the session key using a public key for the server.

11. The medium of claim 9, wherein the step of storing comprises storing the encrypted session key.

12. The medium of claim 9, wherein the step of storing comprises storing the information to a header file, and wherein the method further comprises recompiling the header file with library codes for an SSL protocol to create the plurality of SSL test transactions.

13. The medium of claim 8, wherein the method further comprises initiating a session-key recording session between a client and the server using a handshake protocol, and wherein the steps of generating and storing comprise generating and storing during the recording session.

14. The medium of claim 13, wherein the method further comprises initiating the plurality of SSL test transactions during a testing session using a handshake protocol, and wherein the step of sending comprises sending during the testing session.

15. A computer system comprising:
a storage medium; and
a processor for executing a software program stored on the storage medium for generating a secure socket layer (SSL) load on a server, the software program comprising sets of instructions for performing a method, the method comprising:
generating a session key;
storing information related to the session key; and
sending the stored information to a server as part of each of a plurality of SSL test transactions.

16. The system of claim 15, wherein the method further comprises encrypting the session key, and wherein the step of storing comprises storing the encrypted session key.

17. The system of claim 16, wherein the step of encrypting comprises encrypting the session key using a public key for the server.

18. The system of claim 16, wherein the step of storing comprises storing the encrypted session key.

19. The system of claim 18, wherein the step of storing comprises storing the information to a header file, and wherein the method further comprises recompiling the header file with library codes for an SSL protocol to create the plurality of SSL test transactions.

20. The system of claim 15, wherein the method further comprises initiating a session-key recording session between a client and the server using a handshake protocol, and wherein the steps of generating and storing comprise generating and storing during the recording session, and wherein the method further comprises initiating the plurality of SSL test transactions during a testing session using a handshake protocol, and wherein the step of sending comprises sending during the testing session.
